(19) United States
(12) Patent Application Publication
(10) Pub. No.: US 2024/0368926 A1
(43) Pub. Date: Nov. 7, 2024

(54) BRACKET TO BE ASSEMBLED TO AN INNER SIDE OF A VEHICLE DOOR AND ASSOCIATED ASSEMBLY AND METHOD

(71) Applicant: MINEBEA ACCESSSOLUTIONS ITALIA S.P.A., Pianezza (IT)

(72) Inventors: Marco SAVANT, PIANEZZA (IT); Anthony GUERIN, PIANEZZA (IT); Andrea VIETTI, PIANEZZA (IT)

(73) Assignee: MINEBEA ACCESSSOLUTIONS ITALIA S.P.A., Pianezza (IT)

(21) Appl. No.: 18/769,590

(22) Filed: Jul. 11, 2024

Related U.S. Application Data
(63) Continuation of application No. PCT/EP2023/050492, filed on Jan. 10, 2023.

(30) Foreign Application Priority Data
Jan. 11, 2022 (EP) 22150931.8

(51) Int. Cl. E05B 79/06; E05B 81/76

(52) U.S. Cl. CPC E05B 79/06; E05B 81/77

(57) ABSTRACT

A bracket to be assembled to an inner side of a vehicle door includes at least one electronic switch configured to be activated by a user's touch so as to send a signal to an electronic latch to open the door, and a body. The bracket further includes a second connector part, configured to cooperate with a first connector part of at least one sensor configured to detect the user's hand so as to allow a locking and/or unlocking of the door when the user's hand is detected, so as to connect the at least one sensor to the bracket. The second connector part is secured to the body of the bracket.

### CROSS-REFERENCE TO RELATED APPLICATIONS

This application is a continuation of International Application No. PCT/EP2023/050492, filed on Jan. 10, 2023, which claims priority to and the benefit of EP Application No. 22150931.8, filed on Jan. 11, 2022. The disclosures of the above applications are incorporated herein by reference.

### FIELD

The present disclosure relates to a bracket to be assembled to an inner side of a vehicle door, and to an assembly for opening and/or closing a vehicle door, in particular to an electronic assembly for opening and/or closing the vehicle door.

### BACKGROUND

The statements in this section merely provide background information related to the present disclosure and may not constitute prior art.

Electronic assemblies for opening and/or closing a vehicle door generally comprise a handle, a bracket to which the handle is secured and electronic means configured to unlock the vehicle door and to activate a latch, such as an electronic latch, to open the vehicle door.

Assembling the elements of the assembly can prove difficult, especially the assembly of the parts located from on one side of the vehicle door to the parts located on the other side. In particular, assembling the handle with the sensor on one side, and the bracket on the other side, can be difficult due to the need handle both mechanical securing and electronic connection. This has an impact on the design of these parts which therefore need to occupy a certain volume just to allow the parts to be assembled. However, in this area of the vehicle door, space is already scarce due to the multiple components already necessary for ensuring the door locking/unlocking and opening/closing. Therefore, the need for additional space just to have the assembly parts spread in a way to enable their assembling result in a steric hindrance.

### SUMMARY

This section provides a general summary of the disclosure and is not a comprehensive disclosure of its full scope or all of its features.

An object of the invention is to overcome this problem. An object of the invention is to limit steric hindrance.

The invention concerns a bracket to be assembled to an inner side of a vehicle door. The bracket includes at least one electronic switch configured to be activated by a user's touch so as to send a signal to an electronic latch to open the door, and a body. The bracket further includes a second connector part, configured to cooperate with a first connector part of at least one sensor configured to detect the user's hand so as to allow a locking and/or unlocking of the door when the user's hand is detected, so as to connect the at least one sensor to the bracket, the second connector part being secured to the body of the bracket.

The second connector part being secured facilitates assembling and requires less free space needed for an operator to assemble the sensor and to the bracket.

The bracket can include the following features, considered alone or in any technically possible combination:
the second connector part is configured to cooperate with the first connector part by clipping;
the bracket is configured such that the second connector part extends vertically once the vehicle door is assembled to a vehicle;
the second connector part extends orthogonally to a longitudinal axis of the bracket;
the second connector part is configured to cooperate with the first connector part of the at least one sensor configured to detect the user's hand so as to allow a locking and/or unlocking of the door when the user's hand is detected, so as to electrically connect the at least one sensor to the bracket;
the second connector part is attached to the body of the bracket so as to remain motionless with respect to the body and/or to the electronic switch, for example to the rest of the bracket.

According to a further aspect, the invention concerns an assembly for opening and/or closing a vehicle door, the assembly including: the bracket; a cover member configured to be attached to the bracket; and at least one sensor configured to detect the user's hand so as to allow a locking and/or unlocking of the door when the user's hand is detected. The at least one sensor includes a first connector part. The first connector part and the second connector part are configured to cooperate with each other so as to connect the at least one sensor to the bracket, the second connector part being secured to the body of the bracket.

The at least one sensor is for example arranged on the cover member.

According to yet another aspect, the invention concerns a method for mounting the assembly on a vehicle door, the method including: a first step of assembling the bracket to an inner side of the vehicle door; a second step of connecting the first connector part and the second connector part; a third step of assembling the cover member to an external side of the vehicle door. The second step is performed after the first step, and the third step is performed after the second step.

The method can include the following features, considered alone or in any technically possible combination: the second connector part remains secured to the bracket at least during the mounting of the assembly on the vehicle door; a fourth step of securing the cover member to the bracket, the fourth step being performed after the third step. The fourth step of securing includes: clipping the cover member to the bracket, and
locking the cover member on the bracket by sliding a locking element of the bracket. The clipping includes inserting clipping means of the cover member through at least one aperture of the bracket, the locking resulting from the locking element being positioned at least partially between the clipped clipping means and the aperture.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an assembly for opening and/or closing a vehicle door comprising a bracket according to an example of embodiment of the invention.

FIG. 2 shows a handle and a bracket of the assembly of FIG. 1 before mounting on a vehicle door.

FIG. 3 shows a cross-sectional view of the assembly of FIG. 1 mounted on the vehicle door.

FIG. 4A shows the bracket of FIG. 1 assembled to the vehicle door.

FIG. 4B shows the bracket of FIG. 4A from an overhead view.

FIG. 5A shows the bracket of FIG. 1.

FIG. 5B shows a detail of FIG. 5A.

FIG. 6A is a rear view of the assembly of FIG. 1 where the locking element is in an unlocked position.

FIG. 6B is a rear view of the assembly of FIG. 6A where the locking element is in a locked position.

FIG. 6C is a cross-sectional view of the assembly of FIG. 6B following the A-A cross-section plane.

FIG. 7 shows a cover member of the assembly of FIG. 1.

FIG. 8A shows a sensor secured to the cover member of the assembly of FIG. 1 viewed from the lateral side.

FIG. 8B shows a sensor secured to the cover member of the assembly of FIG. 8A viewed from the rear side.

FIG. 9 shows ranges of the assembly of FIG. 1.

FIG. 10 shows the sensor of the assembly of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

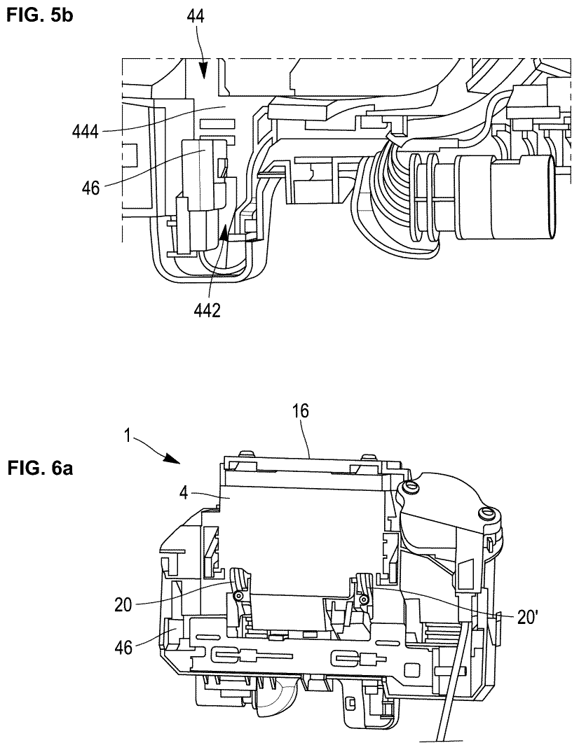

FIGS. 5A and 5B illustrate a bracket. The bracket 4 can be a bracket for a vehicle door, for example a bracket 4 configured to be assembled to an inner side of a vehicle door 2. The bracket 4 comprises at least one electronic switch configured to be activated by a user's touch so as to send a signal to an electronic latch (not shown) to open the vehicle door 2. The bracket 4 further comprises a body 44.

The bracket 4 further comprises a second connector part 6. The second connector part is configured to cooperate with a first connector part 146 of at least one sensor 14, so as to connect the at least one sensor 14 to the bracket 4. The at least one sensor 14 is for example such as described hereafter. The at least one sensor 14 can be configured to detect the user's hand so as to allow a locking and/or unlocking of the door when the user's hand is detected. The second connector part 46 is secured to the body 44 of the bracket.

It is therefore possible to simplify the assembling of the bracket and the sensor together and to the vehicle door. As the second connector part is secured to the body of the bracket, its position remains the same and is predetermined with respect to the rest of the bracket and with respect to the vehicle door once assembled. It is therefore easier to connect the second connector part to the first connector part. For instance, the first connector part can therefore be connected to the second connector part only after the bracket has been mounted on the vehicle door, and for instance before the sensor is assembled to the vehicle door, contrary to the prior art where the two connector parts are connected together only after both the bracket and the cover member are mounted on the vehicle door, making the connection of the connector parts more difficult due to steric hindrance for an operator assembling the door, and resulting in an assembly taking more space due to the arrangements necessary for the operator to access the connector parts. The secured second connector part further allow for a reduction of volume of the assembly due to the connection taking place before the assembly of the cover member.

The second connector part 46 can be attached to the body 44 of the bracket so as to remain motionless with respect to the body 44 and/or to the electronic switch, for example to the rest of the bracket 4.

### Assembly

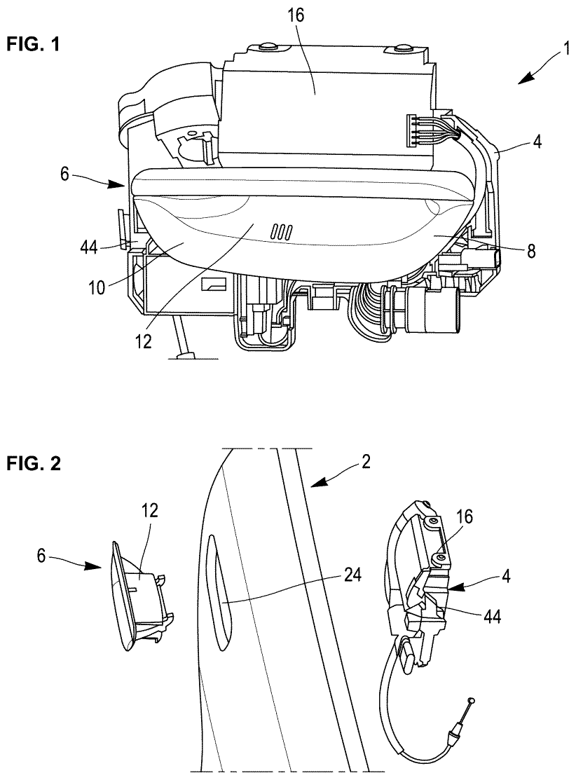

FIG. 1 illustrates an assembly 1 for opening and/or closing a vehicle door 2 (FIG. 2).

The assembly 1 comprises the bracket 4, the bracket being configured to be assembled to an inner side of the door (FIG. 2).

The bracket 4 comprises at least one electronic switch configured to be activated by a user's touch so as to send a signal to an electronic latch (not shown) to open the vehicle door 2.

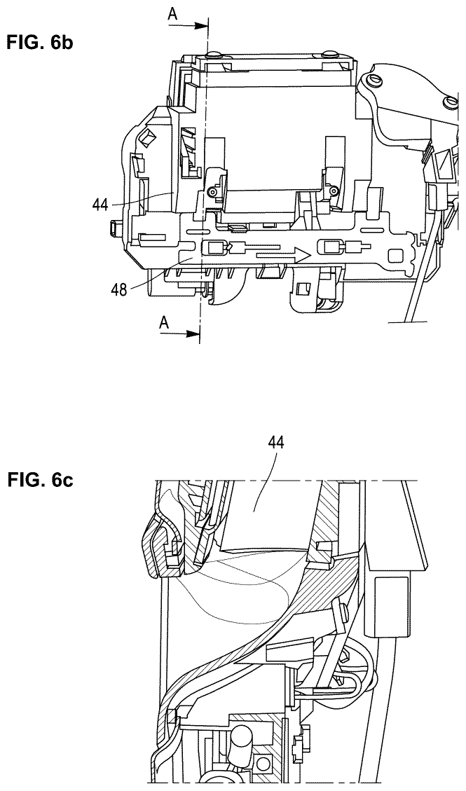

The assembly 1 comprises a cover member 8 configured to be attached to the bracket. The assembly can comprise a handle 6 comprising the cover member 8 (FIGS. 6A, 6B and 6C).

The cover member 8 comprises a frame part 10, and an inner wall part 12 extending from the frame 10 so as to allow an access by the user's hand to the at least one electronic switch of the bracket 4.

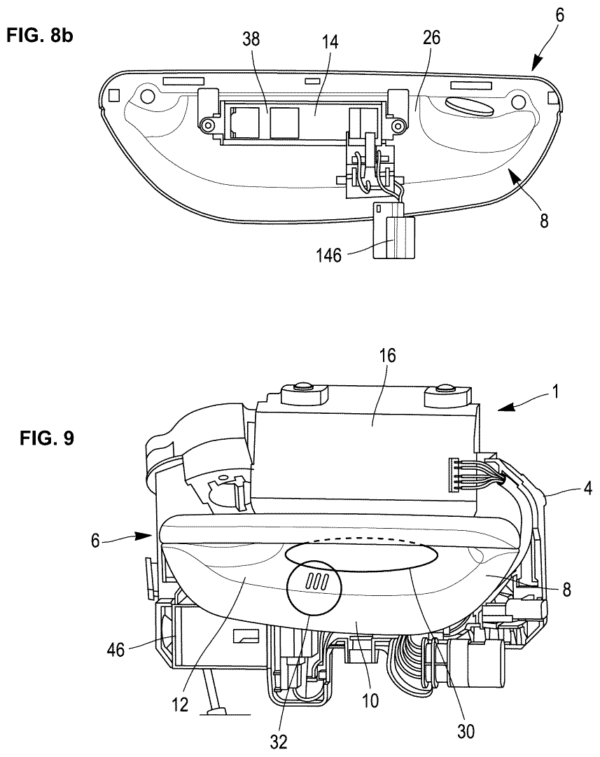

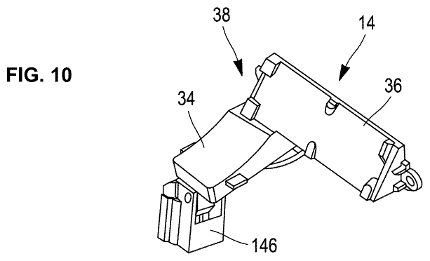

The assembly 1 comprises at least one sensor 14 (FIGS. 8 and 10) configured to detect a user's hand so as to allow a locking and/or an unlocking of the door when the user's hand is detected. The at least one sensor comprises the first connector part 146. As descried hereabove, the first connector part 146 and the second connector part 46 are configured to cooperate with each other so as to connect the at least one sensor 14 to the bracket 4, the second connector part 46 being secured to the body 44 of the bracket 4.

### Bracket

The bracket 4 is configured to be assembled to the inner side of the door (FIG. 2).

By “assembled to the inner side”, it is to be understood that the bracket can be fixed or attached or assembled by any suitable means to the inner side of the door.

By “inner side of the door”, it is understood for example the side of the door destined to face the vehicle interior, by opposition to an outer side of the door destined to be disposed towards the exterior environment.

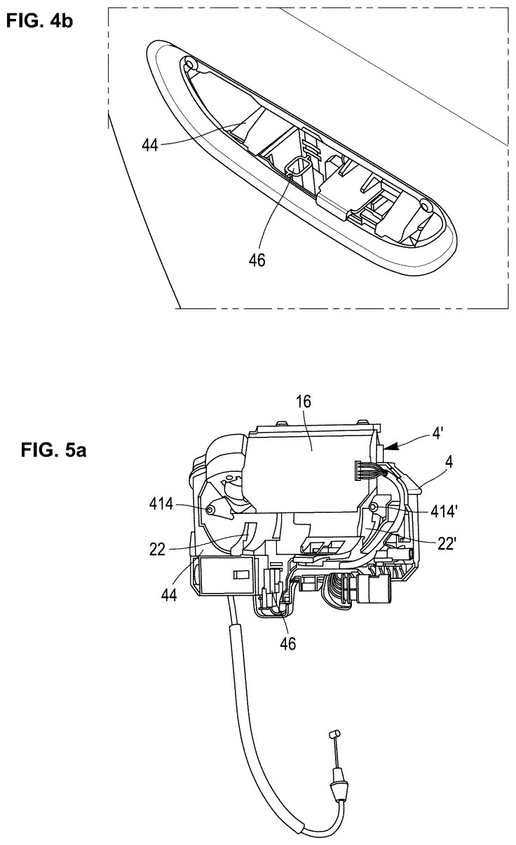

For example, as illustrated in FIGS. 4A and 4B, the bracket 4 is fixed to the inner side of the door by means of screws 414, 414′. For example, the bracket is fixed to the inner side of the door by means a first screw 414 and second screw 414′.

As illustrated in FIGS. 4A and 4B, the bracket 4 is positioned against the inner side of the vehicle door 2.

The bracket 4 comprises at least one electronic switch configured to be activated by a user's touch, for example, by mean of a user's finger touch.

When activated by the user's touch, the electronic switch sends a signal to an electronic latch (not shown) so that the electronic latch opens the vehicle door 2.

As illustrated in FIG. 5, the at least one switch is arranged on an upper part 4′ of the bracket 4.

The at least one switch is arranged behind a casing 16 arranged on the upper part of the bracket 4.

The second connector part 46 is configured to cooperate with the first connector part by clipping. Thus, it is easy to connect both parts without difficulty for an operator assembling the bracket, the cover member and the sensor on the vehicle door.

The second connector part 46 is for instance of a tubular shape, for instance tubular with a rectangular cross-section, for example a rectangular cross-section with rounded angles.

The bracket 4 is for example configured such that the second connector part 46 extends vertically once the vehicle door 4 is assembled to a vehicle. The vertical axis is for example the axis orthogonal to the ground when the vehicle is on a flat ground.

The second connector part 46 extends orthogonally to a longitudinal axis of the bracket 4. The longitudinal axis of the bracket can be defined as the axis defined by the longer dimension of the body 44 of the bracket, and/or the axis defined by the longer dimension of the door opening 24 as defined hereafter when the bracket is mounted on the door.

The second connector part 46 can be secured to the body 44 such that when the bracket is mounted on the vehicle door 2, the second connector part 46 can be accessed through the door opening 24 as defined hereafter, for instance such that it can be connected to the first connector part 146 by an operator, for instance by means of inserting the first connector part 146 through the door opening 24. The second connector part 46 can be secured to the body 44 such that when the bracket is mounted on the vehicle door 2, the second connector part 46 extends within an inner space defined by the body 44 and the vehicle door and leading to the door opening 24 as defined hereafter.

The body 14 can have a recess 442, the second connector part 46 extending within the recess 442. The body can have a cavity 444. The recess 442 can lead to the cavity 444. The inner space can include the recess 442 and/or the cavity 444. The cavity can be directly lead to the door opening 24 as defined hereafter. The cavity 444 is for example configured to receive a part of the cover member 8 and/or of the sensor 14, and/or for forming a part of the path allowing the user's hand towards the electronic switch so as to activate the electronic switch, after passing through the frame part 10.

The second connector part 46 can be secured to a peripheral part of the body 44. The recess 442 can be located in a peripheral part of the body, for instance with respect to the cavity 444. This way, the second connector part 46 can be accessed easily during assembly, at a predetermined location, without blocking the way to the electronic switch once the handle is assembled.

The second connector part 46 can be secured to a lower part of the body 44, for example, with respect to the vertical axis defined hereabove. For this purpose is for example the bracket 4 can comprise a holder, for example an elongated holder, provided on the body 44, for example the holder engaging in a recess of the second connector part 46. Thus, the second connector part 46 can simply be pushed onto the elongated holder so as to be attached to the body 44 so as to remain motionless with respect to the body 44 and/or to the electronic switch. In particular, the holder and/or the second connector part 46 can have a stop so that the second connector part 46 is held in a defined position with respect to the body and/or to the electronic switch.

The recess 442 can be located in a lower part of the body, for example, with respect to the vertical axis defined hereabove, for example lower than the cavity 444. This way, the second connector part 44 can be seen easily by an operator whose eyes are looking to the door opening from above, simplifying the moves of the operator leading connection with the first connector part 146. The operator's view is for instance illustrated by FIG. 4B.

The second connector part 46 can be secured to the body 44 by clipping and/or screws and/or welding.

The body 44 can be integral.

### Cover Member

The cover member 8 of the handle is configured be secured to the bracket 4.

To this end, the bracket 4 and the cover member 8 comprises complementary fastening means which cooperate with each other so that the cover member can be secured to the bracket.

For example, the bracket 4 comprises clipping means 18 (FIG. 4A) and the cover member 8 comprises at least one housing (not visible) configured to receive the clipping means 18 of the bracket 4. The bracket 4 can comprise at least one aperture, the assembly being configured such that the clipping means 18 can be inserted through at least one aperture of the bracket 4, for example so as to reach the at least one housing.

As illustrated in FIGS. 6A, 6B and 6C, the cover member 8 comprises two clipping means 20, 20′ and the bracket 4 comprises two corresponding housings 22, 22′ (FIG. 5A) each configured to receive one of the clipping means 20, 20′ of the cover member 8.

For instance, the assembly is configured such that the cover member can be locked in position to the bracket 4. To this extent, the bracket 4 can comprise a locking element 48. The locking element 48 can be configured such that a sliding of the locking element 48 with respect to a body of the bracket allows for locking the cover member on the bracket. The locking can result from the locking element 48 being positioned at least partially between the clipped clipping means and the aperture.

As illustrated in FIG. 1, the cover member 8 is configured to be assembled to the external side of the vehicle door 2, opposite to the inner side of the door.

To this end, the vehicle door 2 comprises an opening 24 (FIG. 2) so that the cover member 8 can be assembled to the external side of the door and secured to the bracket 4.

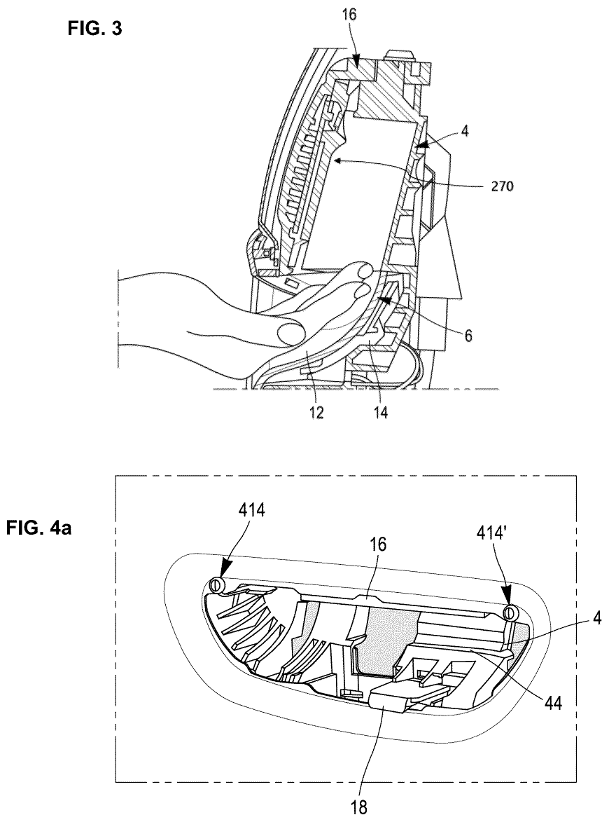

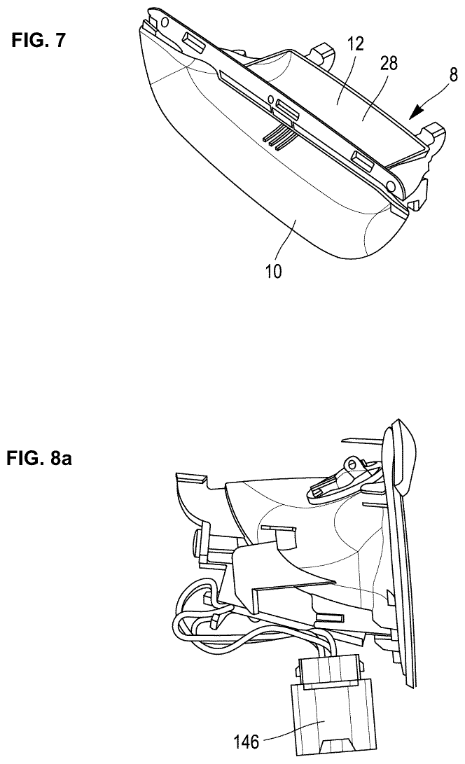

As illustrated in FIG. 7, the frame part 10 of the cover member 8 is sized so that a user's hand can passes through the frame 10 (FIG. 3).

The frame part 10 is configured to be positioned against the external side of the vehicle door.

The inner wall part 12 of the cover member 8 extends from the frame part 10. The inner wall part 12 extends from the frame part 10 so as to allow access by the user's hand the at least one electronic switch 270 of the bracket when the handle is secured to the bracket (FIG. 3). The inner wall part can form a guide to the at least one electronic switch.

To this end, the inner wall part 12 can be tilted with respect to the frame part 8. This configuration permits to guide the user's hand toward the at least one electronic switch arranged on the upper part of the bracket 4 (FIG. 3).

By “upper”, respectively “lower”, it is for example understood with respect to a vertical axis, for example the axis orthogonal to the ground when the vehicle is on a flat ground.

For example, the inner wall part is curved (FIG. 7).

The frame part 10 and the tilted inner wall part may form a bowl shape element. For instance, the frame part 10 and the tilted inner wall part may form a handle of the bowl type, for instance a bowl-shaped handle.

The frame part 10 and the inner wall part 12 can be made integrally.

Optionally, the vehicle door can be manually and mechanically opened, by means of the mechanical lockset.

To this end, the handle 6 comprises a gripping means configured to be graspable by the user's hand to manually open the vehicle door.

For example, the gripping means is arranged on the frame part 10 of the cover member 8.

For example, the gripping means is a strip such as a chrome strip.

### Sensor

The at least one sensor 14 can be positioned such that, when the user's hand is inserted in the cover member in order to reach the at least one electronic switch, the user's hand is detected by the sensor before the user's hand reach the at least one electronic switch so as to allow the unlocking of the door (FIG. 3).

The location of the detection range of the at least one sensor permits to anticipate by a few seconds the unlocking of the vehicle door before the electronic switch is reached by the user's hand to open the vehicle door. This permits to avoid wall effect.

The assembly 1 comprises the at least sensor 14 (FIGS. 8A, 8B and 9) configured to detect a user's hand so as to allow a locking and/or an unlocking of the door when the user's hand is detected. The assembly 1 can comprise one or several such sensor(s) 14.

The sensor 14 is positioned such that, when the user's hand is inserted in the cover member 8 in order to reach the at least one electronic switch, the user's hand is detected by the sensor 14 before the user's hand reach the at least one electronic switch so as to allow the unlocking of the door (FIG. 3).

As illustrated in FIG. 3, the arrangement of the sensor 14 permits to anticipate by a few second the unlocking of the vehicle door before the user's hand reach the electronic switch to open the vehicle door.

For example, once the user's hand is detected by the sensor 14 to unlock the vehicle door, an unlocking process of the vehicle starts.

The unlocking process comprises a step wherein the vehicle detects if the key of the vehicle (arranged in a pocket of the user for example) is near the vehicle to validate the unlocking of the vehicle door, for instance in a certain proximity, for instance at a certain distance of the vehicle.

The detection of the key permits to validate the unlocking of the vehicle door. The detection of the key can be done by means of antennas of the vehicle for example. The vehicle door is then unlocked.

Thus, when the user's hand reaches the switch of the bracket so as to send a signal to an electronic latch to open the door, the vehicle door is already unlocked.

This permits to avoid wall effect, that is to say that opening of the vehicle door happens with a certain delay after the input of the user as the same input commands for unlocking and opening, which have to be performed one after the other.

As illustrated in FIGS. 8A and 8B, the sensor 14 is arranged on the cover member 8, for example on a side 26 of the cover member 8, opposite to a side 28 of the cover member 8 intended to face the user's hand when the user's hand is inserted in the cover member in order to reach the at least one electronic switch, for instance on a rear side of the cover member 8. The sensor is therefore mounted on the door vehicle and on the bracket together with the cover member to which the sensor is preassembled. Therefore, after connection of the first connector part and second connector part, mechanical assembly is permitted through mechanical assembly of the cover member to the vehicle door and/or to the bracket.

For example, the sensor 14 is arranged against the inner wall part 12 of the cover member.

For example, the sensor 14 is a capacitive sensor.

As illustrated in FIG. 9, the sensor 14 has an unlocking sensing range 30 extending at least between the frame part 10 and the at least one electronic switch, for instance between the frame part 10 and the at least one electronic switch.

For example, the unlocking sensing range 30 extends substantially over a large area between the frame part 10 and the at least one electronic switch so that the user's hand can be detected regardless of the position of the user's hand when the user's hand accesses the cover member. For example, the unlocking sensing range 30 extends substantially over the width of the path defined by the inner wall part 12.

The sensor 14 has a locking sensing range 32 extending upstream the unlocking sensing range 30 along the course followed by the user's hand so as to reach the at least one electronic switch.

Upstream, respectively downstream, means for example with respect to a sense going from the outside of the handle towards the electronic switch, for instance with respect to the sense going from the frame part to the electronic switch, for instance with respect to the movement of the user's hand reaching for the electronic switch.

The locking sensing range 32 extends between the frame part 10 and the unlocking sensing range 30.

The locking sensing range 32 extends substantially over an area smaller than the unlocking sensing range 30. The locking sensing range 32 extends at a central part of the inner wall part 12.

For example, the unlocking sensing range 30 extends over an area equal to at least twice the area of the locking sensing range 32.

The locking sensing range 32 is arranged so that once the vehicle door has been closed, the locking sensing range is quickly accessible by the user's hand so as to lock the vehicle door.

As illustrated in FIG. 10, the sensor 14 comprises a locking detection part 34 configured to detect the user's hand so as to allow the unlocking of the door and an unlocking detection part 36 configured to detect the user's hand so as to allow the unlocking of the door.

The locking detection part 34 extends by a non-zero angle from the unlocking detection part 36.

For example, the unlocking detection part 36 extends over an area equal to at least twice the area of the locking detection part 34.

The sensor 14 is a standalone sensor. For example, the sensor is arranged in a casing 38 fixed to the cover member.

The first connector part 146 can be of a complementary shape with respect to the second connector part 46.

The first connector part 146 and the second connector part 46 are configured to electrically connect the bracket 4 and the at least one sensor 14, for instance so as to provide power to the sensor 14 and/or so as to allow the sensor 14 to transmit data.

The first connector part 146 can be configured so as to be movable with respect to a body of the sensor 14, for example with respect to the unlocking detection part 36 and/or to the unlocking detection part 34. The first connector part 146 can be connected to a body of the sensor 14, for example with respect to the unlocking detection part 36 and/or to the unlocking detection part 34, through at least one connecting element, for instance several connecting elements, for instance an electrical and/or mechanical connecting element, connecting the first connector part 146 to the body of the sensor, so that the first connector part 146 remains connected to the rest of the sensor even when the first connector part 146 is moved such that the second connector part 46 can be accessed. The connecting element does not prevent the cover element from being moved freely in translations and rotations with respect to the another part. The connecting element can comprise or form one or more electric wire(s).

### System

A system can comprise such an assembly and the corresponding vehicle door. The assembly is assembled to the vehicle door. The assembly can further comprise the vehicle including the vehicle door mounted thereon.

### Method

A method for mounting the assembly on a vehicle door is described. The method comprises a first step of assembling the bracket 4 to an inner side of the vehicle door 2.

The method comprises a second step of connecting the first connector part 146 and the second connector part 46.

The method comprises a third step of assembling the cover member 8 to an external side of the vehicle door 2.

The second step can be performed after the first step, and the third step can be performed after the second step. That way

The second connector part 46 can remain secured to the bracket 4 at least during the mounting of the assembly on the vehicle door, for example during the first step and the second step and the third step.

The method can further comprise a fourth step of securing the cover member to the bracket, the fourth step being performed after the third step. The fourth step of securing can comprise clipping the cover member 8 to the bracket 4. The fourth step of securing can comprise, for example after clipping, locking the cover member 8 on the bracket 4 by sliding a locking element of the bracket 4. The clipping can comprise inserting the clipping means 18 of the cover member 8 through at least one aperture of the bracket 4, the locking resulting from the locking element 48 being positioned at least partially between the clipped clipping means 18 and the aperture.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A bracket to be assembled to an inner side of a vehicle door, the bracket comprising:
at least one electronic switch configured to be activated by a user's touch so as to send a signal to an electronic latch to open the door, and
a body,
wherein the bracket further comprises a second connector part, configured to cooperate with a first connector part of at least one sensor configured to detect a user's hand so as to allow a locking and/or unlocking of the door when the user's hand is detected, so as to connect the at least one sensor to the bracket, the second connector part being secured to the body of the bracket.

2. The bracket according to claim 1, wherein the second connector part is configured to cooperate with the first connector part by clipping.

3. The bracket according to claim 1, wherein the bracket is configured such that the second connector part extends vertically once the vehicle door is assembled to a vehicle.

4. The bracket according to claim 1, wherein the second connector part extends orthogonally to a longitudinal axis of the bracket.

5. An assembly for opening and/or closing a vehicle door, the assembly comprising:
the bracket according to claim 1,
a cover member configured to be attached to the bracket,
at least one sensor configured to detect the user's hand so as to allow locking and/or unlocking of the door when the user's hand is detected, the at least one sensor comprising a first connector part,
wherein the first connector part and the second connector part are configured to cooperate with each other so as to connect the at least one sensor to the bracket, the second connector part being secured to the body of the bracket.

6. The assembly according to claim 5, wherein the at least one sensor is arranged on the cover member.

7. A method for mounting the assembly according to claim 5 on a vehicle door, the method comprising:
a first step of assembling the bracket to an inner side of the vehicle door;
a second step of connecting the first connector part and the second connector part; and
a third step of assembling the cover member to an external side of the vehicle door,
wherein the second step is performed after the first step, and the third step is performed after the second step.

8. The method according to claim 7, wherein the second connector part remains secured to the bracket at least during the mounting of the assembly on the vehicle door.

9. The method according to claim 7, further comprising a fourth step of securing the cover member to the bracket, the fourth step being performed after the third step.

10. The method according to claim 9, wherein the fourth step of securing comprises:
clipping the cover member to the bracket; and
locking the cover member on the bracket by sliding a locking element of the bracket.

11. The method according to claim 10, wherein the clipping comprises inserting clipping means of the cover member through at least one aperture of the bracket, the locking resulting from the locking element being positioned at least partially between the clipped clipping means and the aperture.
